(19) United States
(12) Patent Application Publication
(10) Pub. No.: US 2011/0194080 A1
(43) Pub. Date: Aug. 11, 2011

(54) PROJECTION TYPE DISPLAY APPARATUS

(75) Inventors: Makoto HOSHINO, Osaka (JP); Naoto SARUWATARI, Osaka (JP)

(73) Assignee: PANASONIC CORPORATION, Osaka (JP)

(21) Appl. No.: 13/009,169

(22) Filed: Jan. 19, 2011

(30) Foreign Application Priority Data
Feb. 5, 2010 (JP) 2010-023890

(51) Int. Cl. G03B 21/16

(52) U.S. Cl. 353/57

(57) ABSTRACT

A projection type display apparatus including a light source device that includes a light source lamp; an image display element that forms an optical image by performing spatial light modulation on projected light from the light source lamp; and a projection optical system that projects the optical image. The light source device includes a reflector that supports the light source lamp; a cooling fan that generates cooling airflow; an annular duct that is attached to a periphery of the reflector and guides the cooling airflow generated by the cooling fan to the inside of the reflector; a rotating plate that is attached inside the duct so as to be capable of freely rotating about an optical axis and has a discharge opening for discharging the cooling airflow guided by the duct toward the light source lamp inside the reflector; and a posture control unit that controls the posture of the rotating plate such that the cooling airflow discharged from the discharge opening is guided to an upper face side of the light source lamp. If the projection type display apparatus is installed at any arbitrary angle from 0° to 360°, it is possible to cool the light source lamp appropriately, thereby achieving a reliable light source lamp having a long service life.

### BACKGROUND OF THE INVENTION

1. Field of the Invention

The present invention relates to a projection type display apparatus that uses a light source lamp, and particularly to a projection type display apparatus having an improved cooling structure for a light source lamp.

2. Description of Related Art

A projection type display apparatus focuses light from a light source lamp with a reflecting mirror such as a reflector, and irradiates the focused light onto an image display element with the use of an optical element such as a prism, so that the light is subjected to optical processing. After the optical processing, the obtained image is enlarged by a projection lens, and projected and displayed on a screen.

A discharge lamp generally used as a light source lamp is filled with mercury, a noble gas, a metal halide and so on. When a certain voltage is applied to the electrodes of the light source lamp, a discharge arc is generated and gas filled inside the lamp undergoes convection. The discharge arc forms the shape of an arch due to the convection of the filled gas and approaches the upper face of the light source lamp, and thus the temperature at the upper face of the light source lamp rises. When the temperature of the light source lamp is excessively high, whitening and decrease in the service life and so on occur. In contrast, when the temperature of the light source lamp is excessively low, blacking and decrease in the luminance and so on occur. Therefore, appropriate control of the temperature of the light source has a great influence on the quality and reliability of the projection type display apparatus.

An example of the conventional cooling structure for the light source lamp of the projection type display apparatus is disclosed in JP 2006-91132A. FIG. 16 is a cross-sectional view of the lamp cooling structure disclosed in JP 2006-91132A. A light source lamp 30 is attached inside a reflector 31, and emits light through a front glass plate 32 arranged in front of the reflector 31. The space formed between the front circumferential portion of the reflector 31 and the front glass plate 32 is sealed off with a duct 33 provided. Cooling air 34 supplied by a cooling fan flows through the duct 33, and is guided to the upper face side of the light source lamp 30 by a rotating guide plate 35 that is capable of freely rotating.

FIG. 17 shows a state of the above-described cooling structure when the installation angle of the projection type display apparatus disclosed in JP 2006-91132A is reversed by 180° with respect to the installation angle in FIG. 16.

The posture of the projection type display apparatus, that is, the posture of the light source lamp is detected by an angle detection system, and the rotating guide plate 35 is displaced rotationally according to the output from the angle detection system. Therefore, when the cooling airflow 34 supplied by the cooling fan advances through the duct 33, the cooling airflow 34 again is guided to the upper face side of the light source lamp 30 by the rotating guide plate 35.

Recently, along with the expanded application of the projection type display apparatus, installation conditions thereof have become diverse, and it is more likely that the projection type display apparatus is installed at various angles as shown in FIG. 18. FIG. 18 shows a casing 1 of the projection type display apparatus with a projection lens 9 arranged at a front portion of and leg units 26 provided on the bottom face of the casing 1, thereby showing installation angles. For example, in the case of 0°, the casing 1 is installed horizontally so that the leg units 26 face downward, which is the most typical state. In the case of 90°, the casing 1 is installed with the projection lens 9 facing upward.

Incidentally, standard values for a temperature range are set with respect to the temperature when the light source lamp is turned on, in order to guarantee the performance of the light source lamp.

When the light source lamp is turned on, in the inside of the light source lamp, the temperature on the upper face side (direction opposite to the direction of gravitational force) rises more than the bottom face side (direction of gravitational force) due to the convection of air. The cooling airflow is supplied by the cooling fan in order to control the temperature of the light source lamp to fall within the temperature range determined by the standard values, and at this time, the cooling airflow is supplied mainly to the upper face side of the light source lamp so that the bottom face side thereof is not excessively cooled.

However, with the lamp cooling structure of the projection type display apparatus having the conventional configuration or that disclosed in JP 2006-91132A, it is impossible to cope with variation in the temperature distribution at the upper face and the bottom face of the light source lamp at various installation angles such as 30°, 45°, or 60°, resulting in a decrease in cooling efficiency. As a result, it is difficult to maintain the temperature of the light source lamp in a proper range, and thus whitening or blacking, decrease in the luminance or service life, and so on are more likely to occur.

### SUMMARY OF THE INVENTION

Therefore, with the foregoing in mind, it is an object of the present invention to enable reliable and efficient control of the temperature of the light source lamp at any arbitrary installation angle, so as to suppress whitening or blacking, decrease in the luminance or service life, and so on, thereby realizing a projection type display apparatus of high quality and high reliability.

A projection type display apparatus according to the present invention includes a light source device that includes a light source lamp; an image display element that forms an optical image by performing spatial light modulation on projected light from the light source lamp; and a projection optical system that projects the optical image. In order to solve the conventional issues described above, the light source device includes: a reflector that supports the light source lamp; a cooling fan that generates cooling airflow; an annular duct that is attached to a periphery of the reflector and guides the cooling airflow generated by the cooling fan to the inside of the reflector; a rotating plate that is attached inside the duct so as to be capable of freely rotating about an optical axis and has a discharge opening for discharging the cooling airflow guided by the duct toward the light source lamp inside the reflector; and a posture control unit that controls the posture of the rotating plate such that the cooling airflow discharged from the discharge opening is guided to an upper face side of the light source lamp.

With this configuration, the posture of the rotating plate is controlled freely by the posture control unit about the optical axis according to an arbitrary posture of the projection type display apparatus, and cooling airflow discharged from the discharge opening is guided stably to the upper face side of the light source lamp. Accordingly, it is possible to realize optimal cooling at any installation angle of the projection type display apparatus, such as 30°, 45° or 60°. In this manner, it is possible to cope with variation in the temperature distribution at the upper face and the bottom face of light source lamp and reliable and efficient control of the temperature of the light source lamp thus becomes possible. Therefore, whitening or blacking, decrease in the luminance or service life, and so on can be suppressed, thereby enabling the provision of a projection type display apparatus of high quality and high reliability.

### BRIEF DESCRIPTION OF THE DRAWINGS

FIG. 1 is a plan view illustrating a configuration of a projection type display apparatus according to Embodiment 1 of the present invention.

FIG. 2 is a plan view showing the cross-section of a basic configuration of a combining optical system including two light source lamps in a light source device of the projection type display apparatus.

FIG. 3 is a perspective view illustrating a lamp cooling structure of the light source device in the projection type display apparatus.

FIG. 4 is a perspective view illustrating a rotating plate portion of the lamp cooling structure in the projection type display apparatus.

FIG. 5 is a lateral cross-sectional view illustrating the lamp cooling structure of the projection type display apparatus.

FIG. 6 is a front cross-sectional view of the lamp cooling structure when the installation angle of the projection type display apparatus is set to 0°.

FIG. 7 is a front cross-sectional view of the lamp cooling structure when the installation angle of the projection type display apparatus is set to 90°.

FIG. 8 is a front cross-sectional view of the lamp cooling structure when the installation angle of the projection type display apparatus is set to 180°.

FIG. 9 is a front cross-sectional view of the lamp cooling structure when the installation angle of the projection type display apparatus is set to 270°.

FIG. 10 is a perspective view illustrating a lamp cooling structure of a projection type display apparatus according to Embodiment 2 of the present invention.

FIG. 11 is a perspective view illustrating a rotating plate portion of the lamp cooling structure in the projection type display apparatus.

FIG. 12 is a front cross-sectional view of the lamp cooling structure when the installation angle of the projection type display apparatus is set to 0°.

FIG. 13 is a front cross-sectional view of the lamp cooling structure when the installation angle of the projection type display apparatus is set to 90°.

FIG. 14 is a front cross-sectional view of the lamp cooling structure when the installation angle of the projection type display apparatus is set to 180°.

FIG. 15 is a front cross-sectional view of the lamp cooling structure when the installation angle of the projection type display apparatus is set to 270°.

FIG. 16 is a lateral cross-sectional view illustrating a conventional lamp cooling structure of a projection type display apparatus.

FIG. 17 is a lateral cross-sectional view illustrating the conventional lamp cooling structure of the projection type display apparatus when the installation angle is reversed by 180°.

FIG. 18 shows various installation angles at which a projection type display apparatus is installed.

### DETAILED DESCRIPTION OF THE INVENTION

A projection type display apparatus of the present invention can be modified based on the above-described configuration as indicated in the following.

For example, it is possible to adopt a configuration in which the cooling fan and the duct are joined such that cooling airflow from the cooling fan advances in the radial direction of the annular shape of the duct.

Alternatively, it is possible to adopt a configuration in which the cooling fan and the duct are joined such that cooling airflow from the cooling fan flows in the tangential direction with respect to the annular shape of the duct, and a blocking wall that blocks a flow path inside the duct is provided adjacent to the discharge opening on a downstream side of the cooling airflow inside the duct.

Also, the posture control unit may be configured by a weight provided on the rotating plate and controls the posture of the rotating plate by changing a rotational angle of the rotating plate by using gravitational force due to the weight of the weight according to the posture of the light source device.

Alternatively, the posture control unit may includes an angle sensor that generates angle information corresponding to the posture of the light source device and a driving device that changes the rotational angle of the rotating plate, and the posture control unit controls the posture of the rotating plate by controlling the driving device based on the angle information from the angle sensor.

Also, the projection type display apparatus may includes an air volume output control unit that adjusts an air volume output of the cooling fan to a state suitable for each posture based on posture information of the projection type display apparatus. With such a configuration, more reliable and efficient control of the temperature of the light source lamp becomes possible such that whitening or blacking, decrease in luminance or service life, and so on is suppressed, thereby realizing a projection type display apparatus of high quality and high reliability.

Also, the projection type display apparatus may includes a plurality of the light source lamps; and an air volume output control unit that adjusts an air volume output of the cooling fans to a state suitable for the lighting state of the plurality of light source lamps according to lighting information of the light source lamps. With such a configuration, even if the temperature distribution at the upper face and the bottom face of the light source lamp varies due to the influence of the opposing light source lamp, control of the temperature of the light source lamp becomes possible, such that whitening or blacking, decrease in luminance or service like, and so on is suppressed, thereby realizing a projection type display apparatus of high quality and high reliability.

Hereinafter, the present invention will be described by way of illustrative embodiments with reference to the drawings.

### Embodiment 1

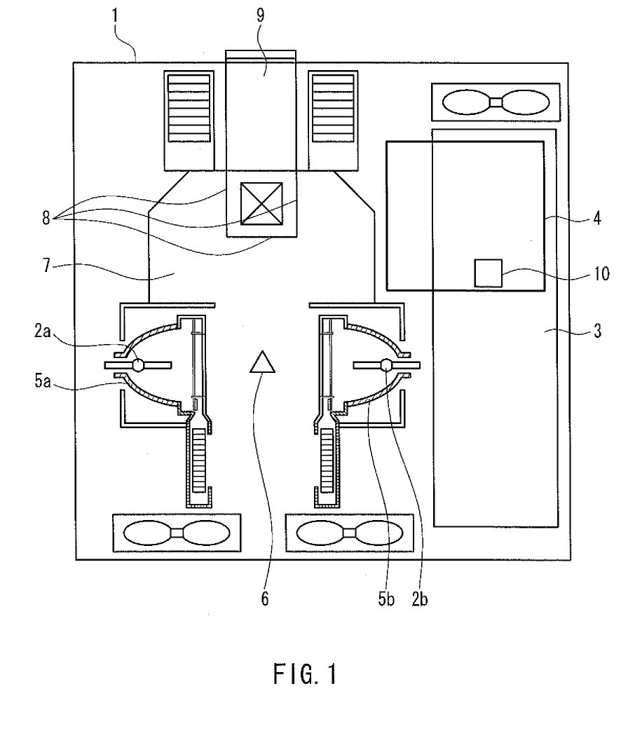

FIG. 1 is a plan view illustrating a configuration of a projection type display apparatus according to Embodiment 1 of the present invention. The basic configuration of the projection type display apparatus is the same as that of a conventional projection type display apparatus. Two light source lamps 2a and 2b are arranged inside a casing 1, and the projection type display apparatus is driven by a power supply unit 3. The entire projection type display apparatus, including the power supply unit 3, is controlled by an electric circuit unit 4.

Light emitted by the two light source lamps 2a and 2b is collected by reflectors 5a and 5b and combined by a combining prism 6. The combined light passes through an optical block unit 7, and is irradiated onto an image display element 8 so as to be subjected to optical processing including spatial light modulation. An optical image formed by the image display element 8 is enlarged by a projection lens 9, and is projected and displayed on a screen. The electric circuit unit 4 includes an angle sensor 10, and outputs an angle detection signal corresponding to the installation posture (angle) of the projection type display apparatus.

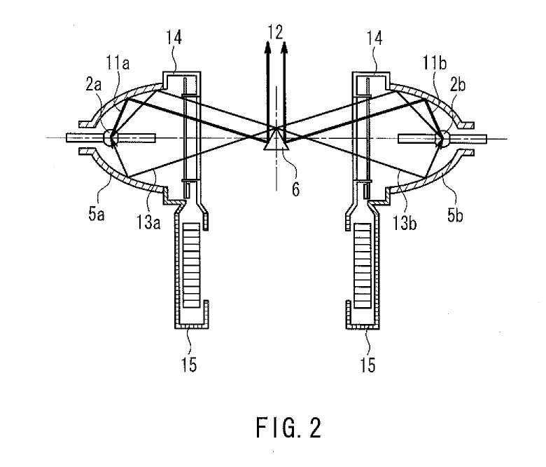

FIG. 2 illustrates a basic configuration of the combining optical system of the light source device including the two light source lamps 2a and 2b. A high-pressure mercury vapor lamp is generally used for the light source lamps 2a and 2b. The output light beams 11a and 11b emitted from the light source lamps 2a and 2b are respectively reflected by reflectors 5a and 5b that are elliptical mirrors, and are focused on the combining prism 6. The combining prism 6 combines the focused light beams along the same optical axis to form combined light 12. Note that a part of the output light from the light source lamps 2a and 2b is not focused on the combining prism 6 and becomes undesired light beams 13a and 13b, which will be described later.

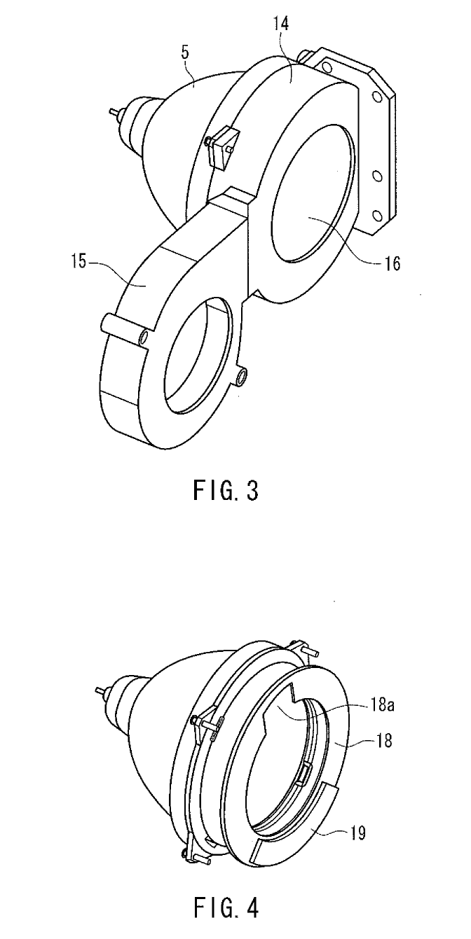

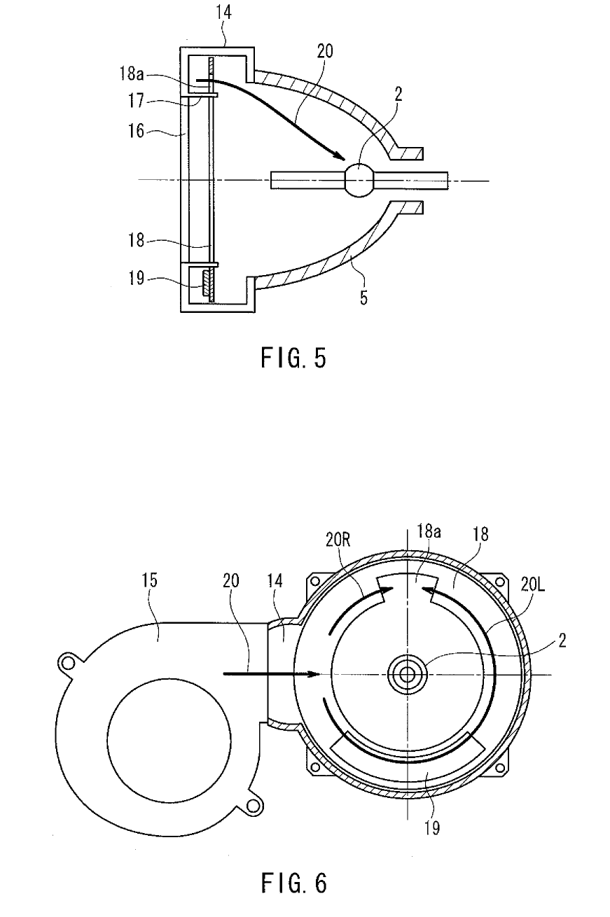

A duct 14 is arranged in the front-side circumferential portion of the reflectors 5a and 5b, and a cooling fan 15 is connected to the duct 14, thereby forming a lamp cooling structure. FIG. 3 shows a perspective view of the cooling structure. Note that the following description is common to the light source lamps 2a and 2b and the reflectors 5a and 5b which are respectively arranged on the light and left. Accordingly, in the following description, the reference numerals thereof are described as the light source lamp 2 and the reflector 5. FIG. 4 is a perspective view of a rotating plate portion of the cooling structure, and shows a state in which the duct 14 and the cooling fan 15 are removed from FIG. 3. FIG. 5 is a lateral cross-sectional view of a portion of the reflector 5 of the cooling structure.

The lamp cooling structure is configured such that a cooling airflow is supplied by the cooling fan 15 to the inside of the reflector 5 that supports the light source lamp 2. Around the reflector 5, the annular duct 14 is provided concentrically with the circumference of the reflector 5. The blast port of the cooling fan 15 is joined to the duct 14 such that cooling airflow advances in the radial direction of the annular shape of the duct 14. A front glass plate 16 is arranged inside the annular shape of the duct 14, and allows passage of the output light from the light source lamp 2 that has been reflected by the reflector 5.

As shown in FIG. 5, an inner circumferential rib 17 is provided forming part of the interior of the duct 14, and an annular flow path is formed so as to be centered on the optical axis of the output light from the light source lamp 2. A rotating plate 18 for guiding cooling airflow to the light source lamp 2 is arranged inside of the duct 14. The rotating plate 18 has a discharge opening 18a formed in a portion thereof, and engages with the inner circumferential rib 17, thereby being supported so as to be capable of freely rotating. The rotating plate 18 further has a weight 19 in a position that is point-symmetrical to the discharge opening 18a with respect the central axis of the rotating plate 18.

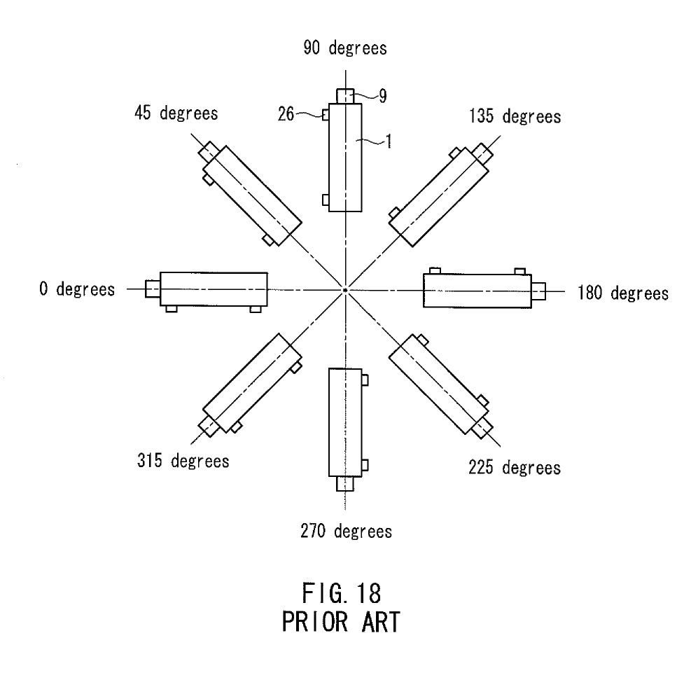

Next, with reference to FIG. 6 to FIG. 9, an effect of the cooling structure configured as described above will be described. FIG. 6 is a front cross-sectional view of the lamp cooling structure as configured above when the installation angle of the projection type display apparatus is set to 0° shown in FIG. 18.

While the light source lamp 2 is turned on, in the inside of the light source lamp 2, the temperature on the upper face side (direction opposite to the direction of gravitational force) rises more than the bottom face side (direction of gravitational force) due to the convection of air. Cooling air 20 is supplied to the inside of the duct 14 by the cooling fan 15 in order to control the temperature of the light source lamp 2 to fall within a range determined by the standard values. The cooling airflow 20 is divided into two streams of cooling airflow 20L and cooling airflow 20R in the concentric duct 14, which are again combined at the discharge opening 18a of the rotating plate 18 and discharged.

At this time, the cooling airflow 20 is supplied mainly to the upper face side such that the bottom face side of the light source lamp 2 is not excessively cooled. For this aim, the posture of the rotating plate 18 is controlled by the weight 19. The rotating plate 18, as described above, engages with the inner circumferential rib 17 that forms part of the duct 14, thereby being attached so as to be capable of freely rotating about the center of the optical axis of the output light of the light source lamp 2. Furthermore, the weight 19 is provided in a position that is point-symmetrical to the discharge opening 18a with respect to the central axis of the rotating plate 18, and therefore the discharge opening 18a is located stably on the upper side (direction opposite to the direction of gravitational force) due to the gravitational force that acts on the weight 19. The cooling airflow 20 supplied from the discharge opening 18a is guided to the upper face side of the light source lamp 2, and cools mainly the upper face side of the light source lamp 2.

In this manner, the weight 19 functions as a posture control unit that controls the posture of the rotating plate 18. When the installation angle of the projection type display apparatus changes, the posture of the light source device including the light source lamp 2 and so on changes. According to the changed posture, the rotation angle of the rotating plate 18 is changed due to the gravitational force generated by the weight of the weight 19, thereby controlling the posture as described above. As a result, the cooling airflow 20 discharged from the discharge opening 18a flows mainly toward the upper face side of the light source lamp 2.

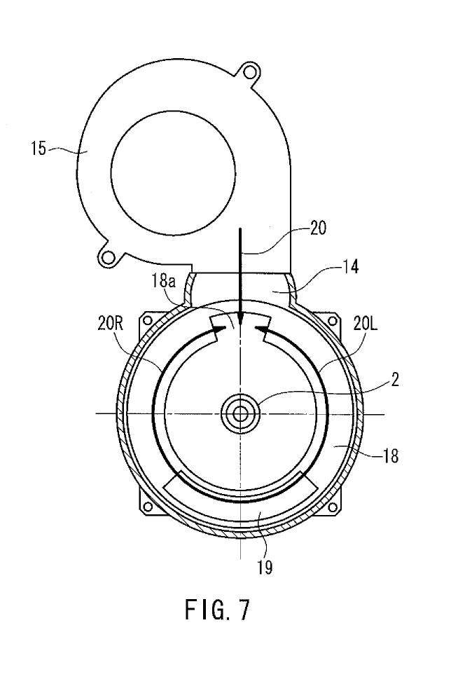

FIG. 7 is a front cross-sectional view of the lamp cooling structure configured as described above when the installation angle of the projection type display apparatus is set to 90°. Similar to the case in which the installation angle is set to 0°, the discharge opening 18a is located stably on the upper side (direction opposite to the direction of gravitational force) due to the gravitational force that acts on the weight 19. The cooling airflow 20 is divided into the two streams of cooling airflow 20L and cooling airflow 20R in the concentric duct 14, which are again combined at the discharge opening 18a of the rotating plate 18 and discharged. The cooling airflow 20 supplied from the discharge opening 18a is guided to the upper face side of the light source lamp 2, and cools mainly the upper face side of the light source lamp 2.

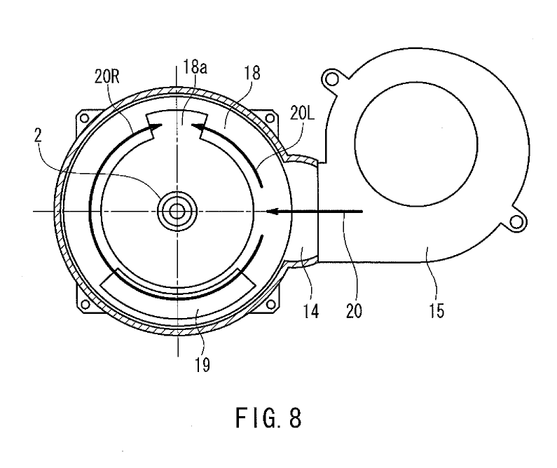

FIG. 8 is a front cross-sectional view of the lamp cooling structure configured as described above when the installation angle of the projection type display apparatus is set to 180°. Similar to the case in which the installation angle is set to 0°, the discharge opening 18a is located stably on the upper side (direction opposite to the direction of gravitational force) due to the gravitational force that acts on the weight 19. The cooling airflow 20 is divided into the two streams of cooling airflow 20L and cooling airflow 20R in the concentric duct 14, which again are combined at the discharge opening 18a of the rotating plate 18 and discharged, or directly discharged from the discharge opening 18a. The cooling airflow 20 supplied from the discharge opening 18a is guided to the upper face side of the light source lamp 2, and cools mainly the upper face side of the light source lamp 2.

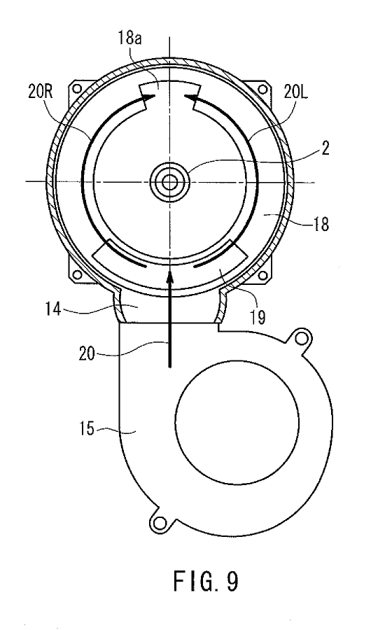

FIG. 9 is a front cross-sectional view of the lamp cooling structure configured as described above when the installation angle of the projection type display apparatus is set to 270°. Similar to the case in which the installation angle is set to 0°, the discharge opening 18a is located stably on the upper side (direction opposite to the direction of gravitational force) due to the gravitational force that acts on the weight 19. The cooling airflow 20 is divided into the two streams of cooling airflow 20L and cooling airflow 20R in the concentric duct 14, which are again combined at the discharge opening 18a of the rotating plate 18 and discharged. The cooling airflow 20 supplied from the discharge opening 18a is guided to the upper face side of the light source lamp 2, and cools mainly the upper face side of the light source lamp 2.

### Embodiment 2

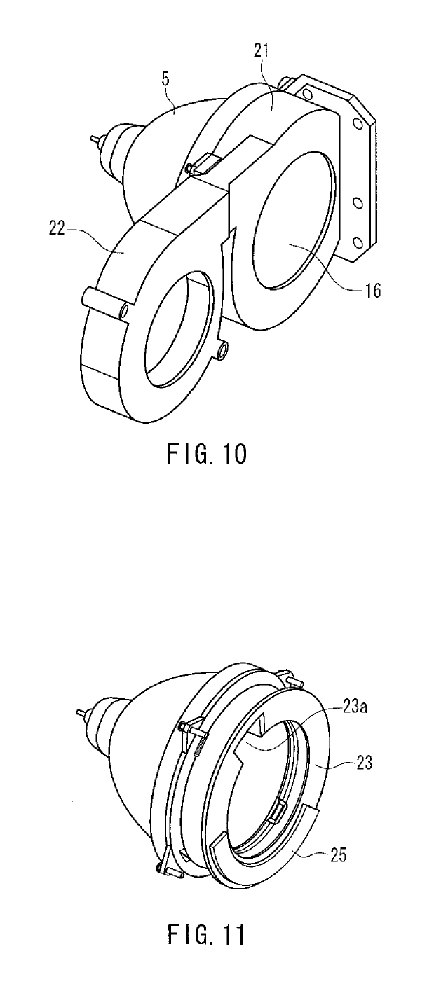

FIG. 10 is a perspective view of a lamp cooling structure included in a light source device of a projection type display apparatus according to Embodiment 2. In Embodiment 2, instead of the duct 14 and the cooling fan 15 in the configuration of Embodiment 1 shown in FIG. 3, a duct 21 and a cooling fan 22 whose shapes are slightly different from those of the duct 14 and the cooling fan 15 are used. FIG. 11 is a perspective view of a rotating plate portion of the cooling structure, and shows a state in which the duct 21 and the cooling fan 22 are removed from FIG. 10.

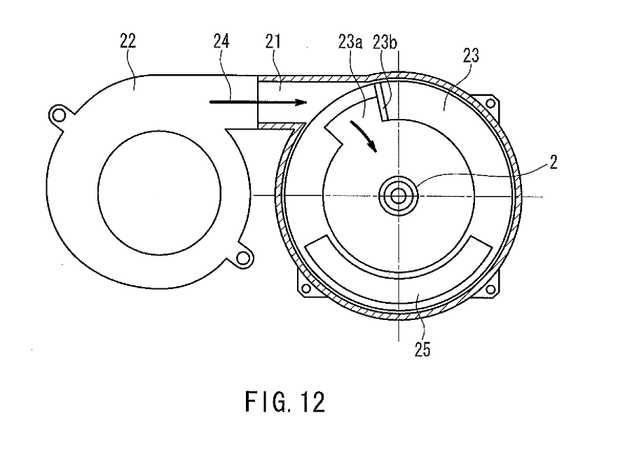

FIG. 12 is a front cross-sectional view of the cooling structure of Embodiment 2 when the installation angle of the projection type display apparatus is set to 0°. The cooling fan 22 and the duct 21 of the cooling structure differ from those of Embodiment 1 in terms of the joining form thereof. Specifically, the cooling fan 22 is joined to the duct 21 such that the cooling airflow from the cooling fan 22 flows in a tangential direction with respect to the annular shape of the duct 21. In Embodiment 1, the cooling airflow 20 from the cooling fan 15 is discharged toward the central axis of the rotating plate 18 and divided into two streams, whereas in Embodiment 2, due to such a configuration of joining, cooling airflow 24 is supplied in the direction along the outer circumference such that the cooling airflow 24 advances in the concentric duct 21 in one direction.

In the configuration in which the cooling airflow 24 advances in the tangential direction with respect to the duct 21, as in this Embodiment, the cooling airflow can be controlled favorably regardless of the installation angle of the projection type display apparatus. On the other hand, with the configuration in which the cooling airflow advances in the radial direction of the duct 14 as in Embodiment 1, although the control of the cooling airflow may be a little improper depending on the installation angle of the projection type display apparatus, such a configuration is advantageous in gaining a large amount of cooling airflow.

A rotating plate 23, similar to the Embodiment 1, engages with an inner circumferential rib (not shown in the drawings) that forms part of the duct 21, and is attached so as to be capable of freely rotating about the optical axis of the output light of the light source lamp 2. In addition, a discharge opening 23a is formed in the rotating plate 23 and a weight 25 is provided on the rotating plate 23. The positional relation between the discharge opening 23a and the weight 25 is set as described later. In addition, a blocking wall 23b is provided adjacent to the discharge opening 23a for blocking the concentric flow path in the duct 21. The blocking wall 23b functions as described below.

As stated above, the cooling airflow 24 from the cooling fan 22 is supplied along the direction of the outer circumference (tangential direction) of the rotating plate 23 such that the cooling airflow 24 advances in the concentric duct 21 in one direction. However, since the blocking wall 23b is formed in the rotating plate 23, in the state of FIG. 12, the cooling airflow 24 is blocked by the blocking wall 23b that is arranged ahead thereof. Accordingly, the cooling airflow 24 cannot travel in the duct 21 in the circumferential direction, and is discharged from the discharge opening 23a of the rotating plate 23 into the reflector 5.

The weight 25 provided on the rotating plate 23 is arranged not in a position that is point-symmetrical to the discharge opening 23a with respect to the central axis of the rotating plate 23, but rather is arranged in a position that is shifted from the point-symmetrical position toward the blast port of the cooling fan 22 by a small angle. This is for causing the cooling airflow 24 supplied from the discharge opening 23a to be guided to the upper face side of the light source lamp 2 so as to cool mainly the upper face side of the light source lamp 2. That is, the discharge opening 23a is controlled so as to be located stably at a constant position due to the gravitational force that acts on the weight 25. At this time, the discharge opening 23a is controlled so as to be located at a position shifted by a small angle from the position directly above the central axis of the rotating plate 23, and therefore the cooling airflow 24 is directed smoothly to the upper portion of the light source lamp 2.

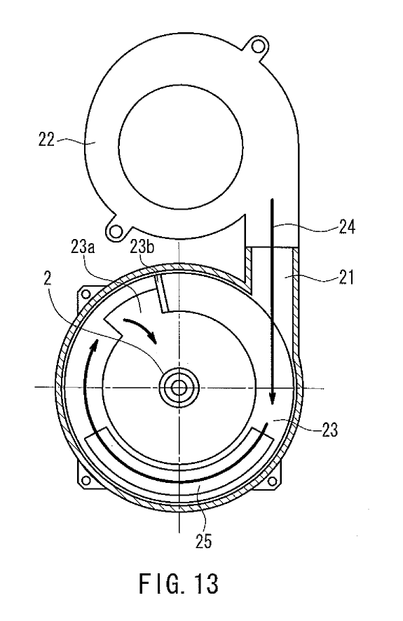

FIG. 13 is a front cross-sectional view of the lamp cooling structure of Embodiment 2 when the installation angle of the projection type display apparatus is set to 90°. Similar to the case in which the installation angle is set to 0°, the discharge opening 23a is located stably in a constant position due to the gravitational force that acts on the weight 25. The cooling airflow 24 is supplied to flow in the concentric duct 21 in the circumference direction, and is guided by the blocking wall 23b of the rotating plate 23 that is arranged ahead thereof, so as to be discharged from the discharge opening 23a of the rotating plate 23. The cooling airflow 24 supplied from the discharge opening 23a is guided to the upper face side of the light source lamp 2, and cools mainly the upper face side of the light source lamp 2.

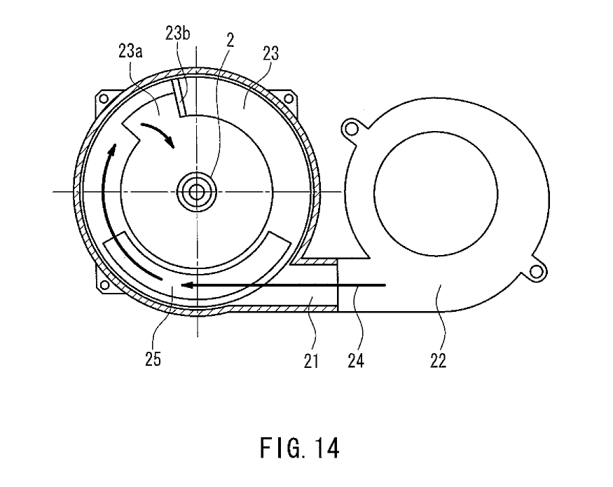

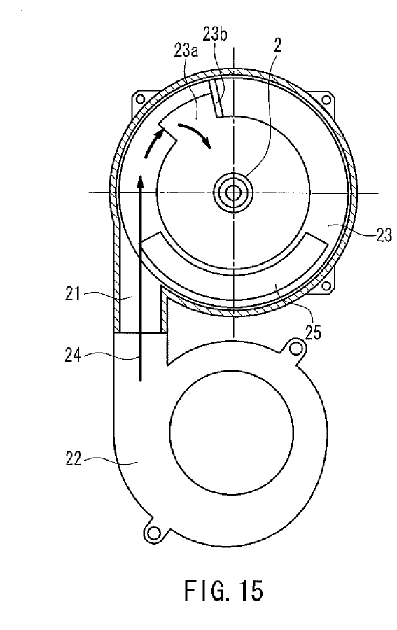

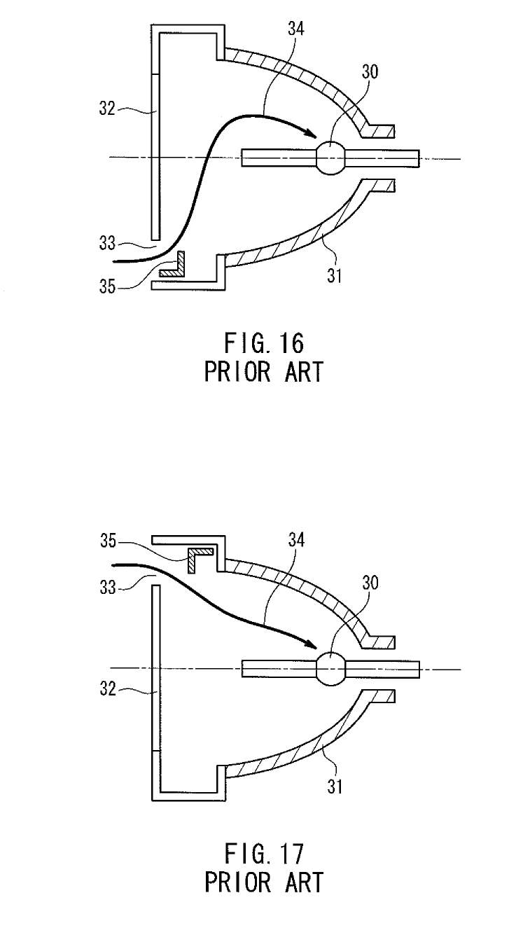

Similarly, FIG. 14 is a front cross-sectional view of the lamp cooling structure of Embodiment 2 when the installation angle of the projection type display apparatus is set to 180°. FIG. 15 is a front cross-sectional view of the lamp cooling structure of Embodiment 2 when the installation angle of the projection type display apparatus is set to 270°. In both cases of FIGS. 14 and 15, similar to the case in which the installation angle is set to 0°, the discharge opening 23a is located stably in a constant position due to the gravitational force that acts on the weight 25. The cooling airflow 24 is supplied in the concentric duct 21 in the circumference direction, and is discharged into the reflector 5 by the blocking wall 23b of the rotating plate 23 that is arranged ahead thereof, and the discharge opening 23a of the rotating plate 23. The cooling airflow 24 supplied from the discharge opening 23a is guided to the upper face side of the light source lamp 2, and cools mainly the upper face side of the light source lamp 2.

With the configuration described above, the discharge opening 23a is located stably on the upper side (direction opposite to the direction of gravitational force) due to the gravitational force that acts on the weight 25 at any installation angle ranging from 0° to 360°, such as 30°, 45° or 60°, rather than being limited to 0°, 90°, 180° and 270°, so that mainly the upper face side of the light source lamp 2 can be cooled. Also, it is possible to cope with variation in the temperature distribution at the upper face and the bottom face of the light source lamp, thereby enabling reliable and efficient control of the temperature of the light source lamp. As a result, it is possible to suppress whitening or blacking, decrease in the luminance or service life, and so on, thereby realizing a projection type display apparatus of high quality and high reliability.

Note that the projection type display apparatus of the present invention can also adopt, for the posture control unit, a configuration in which the posture of the rotating plates 18 and 23 is controlled with the use of angle information based on the angle detection signal from the angle sensor 10, instead of the configuration in which the weight is used. For example, a configuration can be adopted in which the rotating plates 18 and 23 can be driven to rotate by a power transmission device formed by combining a motor and gears, and the electric circuit unit 4 controls the power transmission device based on the angle information from the angle sensor 10. The posture of the rotating plates 18 and 23 is controlled by such a configuration such that the discharge openings 18a and 23a of the rotating plates 18 and 23 are located stably on the upper side (direction opposite to the direction of gravitational force), thereby enabling cooling mainly of the upper face side of the light source lamp 2.

Also, the projection type display apparatus of the present invention preferably includes an air volume output control unit for adjusting the air volume output of the cooling fan based on the posture information of the projection type display apparatus. For example, the air volume output of the cooling fan is adjusted in accordance with the angle information from the angle sensor 10 or installation information that the user and so on inputs when the projection type display apparatus is installed. The air volume output control unit can be configured by the electric circuit unit 4. Setting the air volume output of the cooling fan suitable for each posture enables cooling mainly of the upper face side of the light source lamp 2. With such a configuration, reliable and efficient control of the temperature of the light source lamp becomes possible, and accordingly whitening or blacking, reduction in the luminance or service life, and so on is suppressed, thereby realizing a projection type display apparatus of high quality and high reliability.

Also, the projection type display apparatus of the present invention can adjust the air volume output of the cooling fan also in the case where the projection type display apparatus includes a plurality of light source lamps.

As described above, a part of the light output from light source lamps 2a and 2b of FIG. 2 is not focused on the combining prism 6, and becomes undesired light beams 13b and 13a. The undesired light beams 13a and 13b respectively are reflected by the reflectors 5a and 5b that are elliptical mirrors of the opposing light sources, and respectively focused on the opposing light source lamps 2a and 2b. Therefore, when the light source lamps 2a and 2b are turned on at the same time, they irradiate each other with undesired light that is a part of the output light. For this reason, the degree of temperature rise in the light source lamp is greater than the case in which only one of the light source lamps is turned on, which causes issues such as whitening, decrease in the service life, and so on of the light source.

Therefore, in the case where the projection type display apparatus includes a plurality of light source lamps, an air volume output control unit that adjusts the air volume output of the cooling fan according to the lighting information thereof is preferably provided. As a result, even if the temperature distribution at the upper face and the bottom face of the light source lamp varies due to the influence of the opposing light source lamp, control of the temperature of the light source lamp is enabled and whitening or blacking, decrease in the luminance or service like, and so on is suppressed, thereby realizing a projection type display apparatus of high quality and high reliability. The air volume output control unit can be configured by the electric circuit unit 4.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A projection type display apparatus comprising:
a light source device that includes a light source lamp;
an image display element that forms an optical image by performing spatial light modulation on projected light from the light source lamp; and
a projection optical system that projects the optical image,
wherein the light source device comprises:
a reflector that supports the light source lamp;
a cooling fan that generates cooling airflow;
an annular duct that is attached to a periphery of the reflector and guides the cooling airflow generated by the cooling fan to the inside of the reflector;
a rotating plate that is attached inside the duct so as to be capable of freely rotating about an optical axis and has a discharge opening for discharging the cooling airflow guided by the duct toward the light source lamp inside the reflector; and
a posture control unit that controls the posture of the rotating plate such that the cooling airflow discharged from the discharge opening is guided to an upper face side of the light source lamp.

2. The projection type display apparatus according to claim 1,
wherein the cooling fan and the duct are joined such that cooling airflow from the cooling fan advances in the radial direction of the annular shape of the duct.

3. The projection type display apparatus according to claim 1,
wherein the cooling fan and the duct are joined such that cooling airflow from the cooling fan flows in the tangential direction with respect to the annular shape of the duct, and
a blocking wall that blocks a flow path inside the duct is provided adjacent to the discharge opening on a downstream side of the cooling airflow inside the duct.

4. The projection type display apparatus according to claim 1,
wherein the posture control unit is configured by a weight provided on the rotating plate and controls the posture of the rotating plate by changing a rotational angle of the rotating plate by using gravitational force due to the weight of the weight according to the posture of the light source device.

5. The projection type display apparatus according to claim 1,
wherein the posture control unit comprises an angle sensor that generates angle information corresponding to the posture of the light source device and a driving device that changes the rotational angle of the rotating plate, and
the posture control unit controls the posture of the rotating plate by controlling the driving device based on the angle information from the angle sensor.

6. The projection type display apparatus according to claim 1, comprising:
an air volume output control unit that adjusts an air volume output of the cooling fan to a state suitable for each posture based on posture information of the projection type display apparatus.

7. The projection type display apparatus according to claim 1 comprising:
a plurality of the light source lamps; and
an air volume output control unit that adjusts an air volume output of the cooling fans to a state suitable for the lighting state of the plurality of light source lamps according to lighting information of the light source lamps.
